(19) United States
(12) Patent Application Publication
(10) Pub. No.: US 2005/0017592 A1
(43) Pub. Date: Jan. 27, 2005

(54) Rotary electric machine having armature winding connected in delta-star connection

(75) Inventor: Akira Fukushima, Kariya-city (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 10/863,747

(22) Filed: Jun. 9, 2004

(30) Foreign Application Priority Data
Jul. 24, 2003 (JP) 2003-279249

(51) Int. Cl. H02K 1/00

(52) U.S. Cl. 310/179

(57) ABSTRACT

An armature of a rotary electric machine includes a cylindrical armature core and an armature winding wound on the core. The armature winding is connected in a combination of a delta-winding and a star-winding, both composed of three phase windings. Each phase winding includes plural winding units, the connection of which is easily changeable to alter a ratio of the winding units forming the delta-winding and the star-winding. When a higher number of winding units form the star-connection, the armature is applicable to a higher voltage system. A pair of the delta-star windings may be wound in the same armature core and connected in parallel to each other to thereby increase a current capacity of the armature. Lead wires connecting ends of the respective phase windings are positioned within a semi-circular area at an axial end of the cylindrical armature core to shorten the length of the lead wires.

### CROSS-REFERENCE TO RELATED APPLICATION

This application is based upon and claims benefit of priority of Japanese Patent Application No. 2003-279249 filed on Jul. 24, 2003, the content of which is incorporated herein by reference.

### BACKGROUND OF THE INVENTION

1. Field of the Invention

The present invention relates to a rotary electric machine such as an electric motor, and more particularly to improvement of an armature winding of the rotary electric machine.

2. Description of Related Art

An example of an armature winding of a rotary electric machine having a delta-star winding is disclosed in JP-A-2002-281706. A relevant portion of the armature winding is shown in FIG. 17 attached to this specification. The armature winding is composed of a combination of a delta-winding 520 and a star-winding 521. One end 501 of a Y-phase winding 505 is connected to an intermediate point 501 of an X-phase winding, one end 506 of a Z-phase winding 510 is connected to an intermediate point 506 of the Y-phase winding 505, and one end 511 of an X-phase winding 500 is connected to an intermediate point 511 of the Z-phase winding 510. As a result, respective halves of the three phase windings X, Y, Z constitute a delta winding 520, and the rest of these phase windings constitutes a start-winding 521.

In the conventional armature winding described above, a turn ratio of the delta-winding and the star-winding is changed by changing the positions of the intermediate points 501, 506 and 511 on respective phase windings 500, 505 and 510. Because ends of the phase windings are connected to respective intermediate points 501, 506, 511 of other phase windings, it is unavoidable to position lead wires connecting phase windings all around an axial end of an armature core. Further, a length of these lead wires becomes long, and accordingly, power loss in resistance of the lead wires becomes higher.

### SUMMARY OF THE INVENTION

The present invention has been made in view of the above-mentioned problem, and an object of the present invention is to provide an improved armature winding of a rotary electric machine, and more particularly to provide an armature winding, in which a turn ratio of a delta-winding to a star-winding is easily changed and a length of lead wires is shortened.

The armature of a rotary electric machine includes a cylindrical armature core and an armature winding disposed in slots formed in the armature core. The armature winding is composed of a plurality of U-shaped conductor segments, open ends of which are positioned at an axial end of the armature core and electrically connected. The armature winding is arranged in a delta-star winding which is a combination of a delta-winding connected in delta-connection and a star-winding connected in star-connection. The delta-star winding is composed of three phase windings, i.e., U-phase winding, V-phase winding and W-phase winding. Each phase winding includes three, four or more phase winding units. For example, the U-phase winding may be composed of four phase winding units U1-U4, the V-phase winding may be composed of four phase winding units V1-V4 and the W-phase winding may be composed of four phase winding units W1-W4.

Some of the phase winding units form the delta-winding and the rest forms the star-winding. For example, the phase winding units U3, U4; V3, V4; W3, W4 form the delta-winding and the other phase winding units U1, U2; V1, V2; W1, W2 form the star-winding. The number of phase-winding units forming the delta-winding can be easily changed by changing positions of connecting the phase winding units. When the star-winding includes a higher number of phase winding units, the armature winding is applicable to a system having a higher voltage, while the delta-winding includes a higher number of phase winding units, the armature winding is advantageously applicable to a system having a lower voltage.

The ends of the phase windings are led out from the slots and positioned at an axial end of the armature core, and the lead wires are positioned within a semi-circular area of the axial end, namely, within 180 degrees in the central angle of the cylindrical armature core. In this manner, the length of the lead wires can be shortened and power loss due to the resistance of the lead wires can be minimized.

It is possible to wind a pair of the delta-star windings in the same armature core and to connect them in parallel to each other. In this case, current capacity of the armature winding is doubled. Alternatively, phase winding units in both of the delta-star winding units may be connected in series. For example, in the case of four phase windings are used in each delta-star winding, a combined delta-winding is formed by connecting four phase winding units in series in each phase and the combined star-winding is also formed by connecting four phase winding units in series in each phase. By thus connecting the phase-winding units in series, the armature winding can be made applicable to a high voltage system.

According to the present invention, the armature can be made applicable to various systems having different voltages and current capacities by simply changing electrical connections in its delta-star winding. Other objects and features of the present invention will become more readily apparent from a better understanding of the preferred embodiments described below with reference to the following drawings.

### BRIEF DESCRIPTION OF THE DRAWINGS

FIG. 1 is a cross-sectional view showing a rotary electric machine having an armature according to the present invention;

FIG. 2 is a schematic view showing a part of an armature core in which an armature winding is disposed;

FIG. 3 is a perspective view showing conductor segments forming the armature winding;

FIG. 4 is a circuit diagram showing a connection of the armature winding as a first embodiment of the present invention;

FIG. 5 is a circuit diagram showing a part of the connection shown in FIG. 4 in an enlarged scale;

FIG. 6 is a diagram showing an armature winding disposed in slots of an armature core;

FIG. 7 is a part of the same diagram as shown in FIG. 6 to be continued thereto;

FIG. 8 is a diagram showing an armature winding disposed in slots of an armature core as a second embodiment of the present invention;

FIG. 9 is a circuit diagram showing a connection of the armature winding as a second embodiment of the present invention;

FIG. 10 is a circuit diagram showing a connection of the armature winding as a third embodiment of the present invention;

FIG. 11 is a diagram showing the armature winding disposed in slots of an armature core as the third embodiment of the present invention;

FIG. 12 is a circuit diagram showing a connection of an armature winding as a fourth embodiment of the present invention;

FIG. 13 is a circuit diagram showing a connection of an armature winding as a fifth embodiment of the present invention;

FIG. 14 is a circuit diagram showing a connection of an armature winding as a sixth embodiment of the present invention;

FIG. 15 is a circuit diagram showing a connection of an armature winding as a first comparative example;

FIG. 16 is a circuit diagram showing a connection of an armature winding as a second comparative example; and

FIG. 17 is a circuit diagram showing an armature winding in a conventional rotary electric machine.

### DETAILED DESCRIPTION OF THE PREFERRED EMBODIMENTS

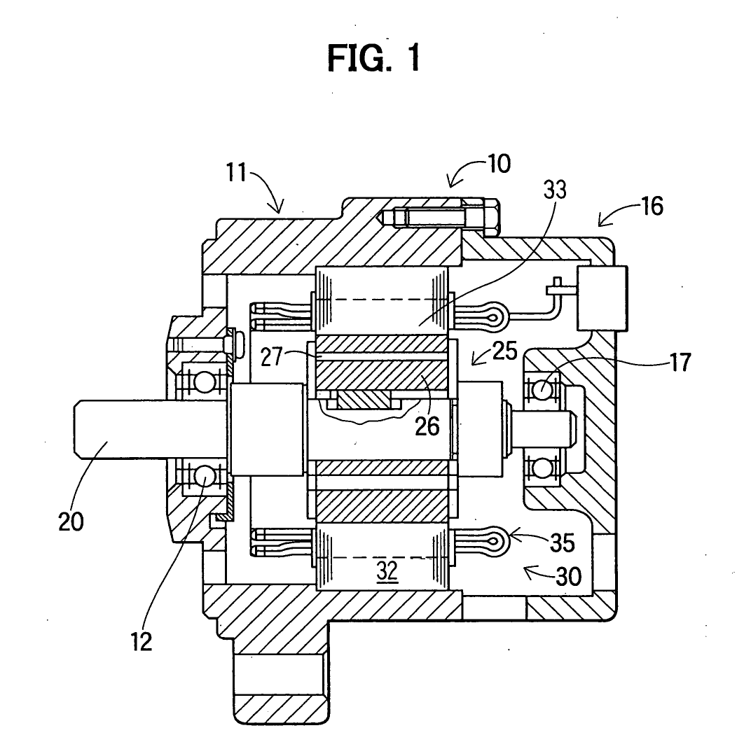

A first embodiment of the present invention will be described with reference to FIGS. 1-7. In FIG. 1, an alternating current motor to which the present invention is applied is shown. The motor is composed of a housing 10 including a front housing 11 and a rear housing 16, an armature 30 fixed in the housing 10, a rotor 25 rotatably supported in the housing with a pair of bearings 12 and 17. The front housing 11 and the rear housing 16 are connected to each other by connecting bolts. The armature 30 is composed of an armature core 32 fixed to the housing 10 and an armature winding 35 disposed in slots 33 formed in the armature core 32. The rotor 25 is composed of a rotor shaft 20, a rotor core 26 fixed to the rotor shaft 20 and permanent magnets 27 embedded in the rotor core 26. Rotational torque of the motor is taken out from a pulley (not shown) connected to the rotor shaft 20.

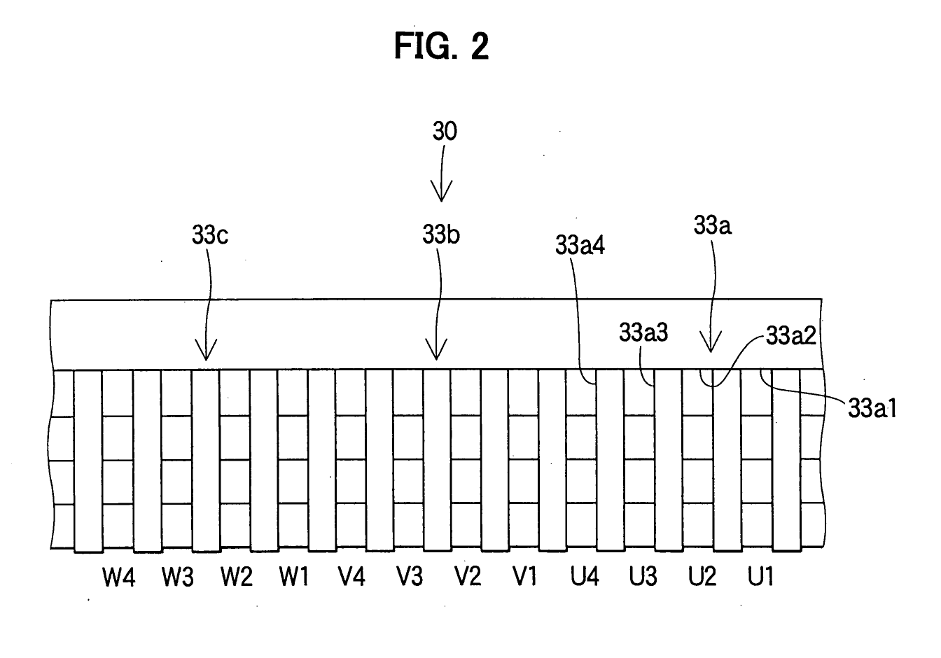

The armature 30 will be described in detail with reference to FIGS. 2-7. The armature core 32 has a cylindrical shape, and the plural slots 33 (48 slots in this particular embodiment) are formed in its inner bore at equal intervals. As shown in FIG. 2, neighboring 4 slots form a group of slots for containing respective phase windings. For example, a group of slots 33a for U-phase windings U1-U4 is composed of four slots, 33a1, 33a2, 33a3 and 33a4. Similarly, a group of slots 33b for V-phase windings V1-V4 is composed of four slots, and a group of slots 33c for W-phase windings W1-W4 is composed of four slots.

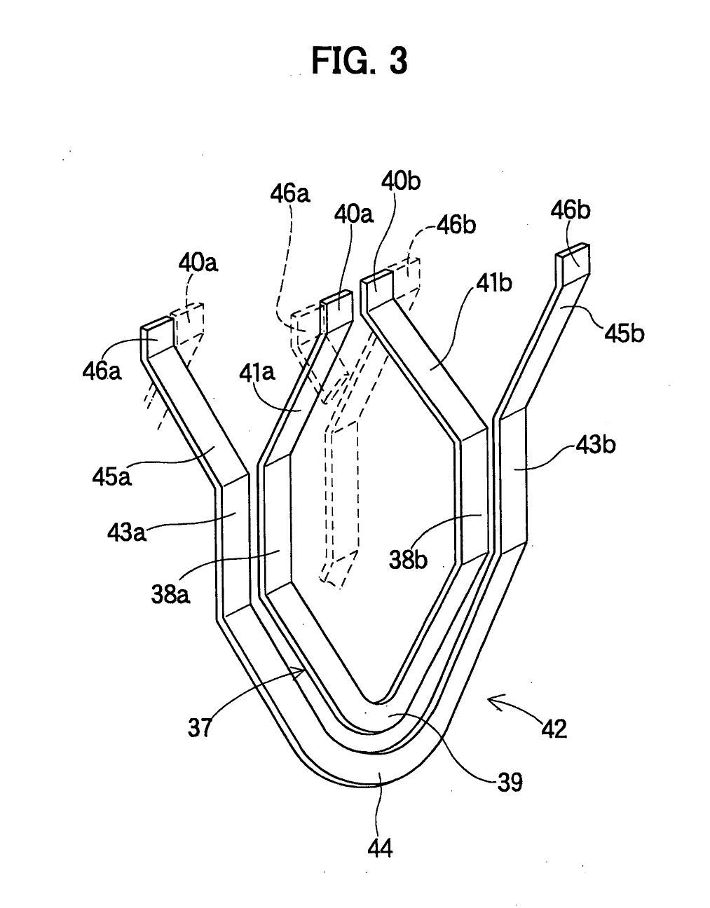

Conductor segments including inner conductor segments 37 and outer conductor segments 42, shown in FIG. 3, are disposed in the slots 33 with an insulator (not shown) interposed therebetween. The inner conductor segment 37 is formed by bending a conductor wire such as a copper wire having a rectangular cross-section. The inner conductor segment 37 has a pair of straight portions 38a, 38b which are disposed in the slots 33, a U-shaped portion 39 connecting the pair of straight portions 38a, 38b, and a pair of angled portions 41a, 41b. The angled portions 41a and 41b are bent so that they become close to each other. The angled portions 41a, 41b include respective end portions 40a, 40b. The outer conductor segment 42 is similarly formed and has a pair of straight portions 43a, 43b which are disposed in the slots 33, a U-shaped portion 44 connecting the pair of straight portions 43a, 43b, and a pair of angled portions 45a, 45b. The angled portions 45a, 45b are bent so that they become apart from each other. The angle portions 45a, 45b include respective end portions 46a, 46b.Other conductor segments to be electrically connected to the conductor segments 37 and 42 are shown with dotted lines.

The U-shaped portions 39, 44 extend from an axial end surface of the armature core 32 (to the right side in FIG. 1), and the angled portions 41a, 41b, 45a, 45b extend from the other axial end surface of the armature core 32 (to the left side in FIG. 1). The end portions 40a and 46a, and the end portions 40b and 46b are electrically connected to each other. Plural inner conductor segments 37 and plural outer conductor segments 42 form the phase-windings, U-phase winding, V-phase winding and W-phase winding in the manner described below.

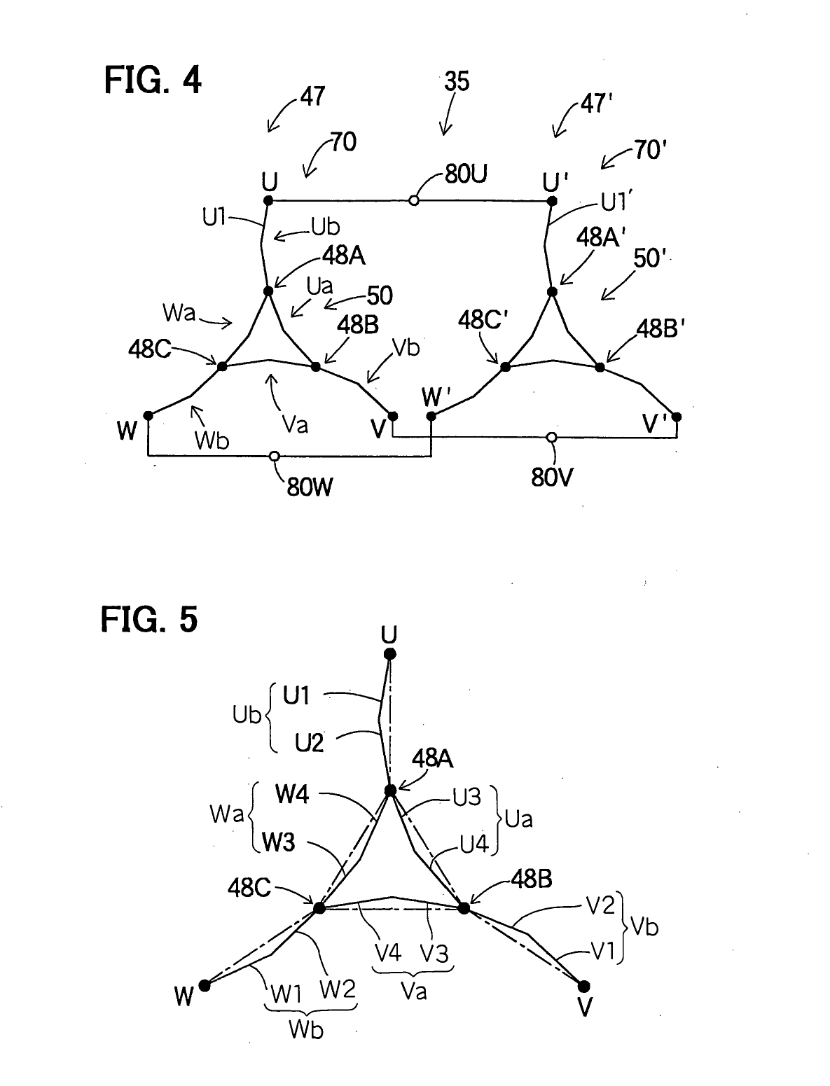

As shown in FIG. 4, the armature winding 35 has a pair of delta-star windings 47 and 47′. Since both windings 47 and 47′ are identical, the delta-star winding 47 will be described in detail. Both windings 47 and 47′ are connected in parallel. The delta-star winding 47 includes a delta winding 50 composed of a first U-phase winding Ua, a first V-phase winding Va and a first W-phase winding Wa, and a star winding 70 composed of a second U-phase winding Ub, a second V-phase winding Vb and a second W-phase winding Wb. Ua, Va and Wa are disposed in the respective slots 33, each being apart from one another by 120° electrical angle, and are connected in a delta connection. Ub, Vb and Wb are disposed in the respective slots 33, each being apart from one another by 120° electrical angle, and are connected in a star connection.

As shown in FIG. 5, Ub and Ua are composed of U-phase winding units U1, U2 and U3, U4, respectively. U1-U4 are connected in series. Similarly, Vb and Va are composed of V-phase winding units V1, V2 and V3, V4, respectively. V1-V4 are connected in series. Wb and Wa are composed of W-phase winding units W1, W2 and W3, W4, respectively. W1-W4 are connected in series. The delta-winding 50 has junctions 48A, 48B and 48C, and the star-winding 70 has phase terminals U, V and W.

The other delta-star winding 47′ includes a delta-winding 50′ having junctions 48A′, 48B′ and 48C′ and a star-winding 70′ having phase terminals U′, V′ and W′. The pair of delta-star windings 47 and 47′ are connected in parallel, i.e., the phase terminals U and U′ are connected to a common U-phase terminal 80U, the phase terminals V and V′ are connected to a common V-phase terminal 80V and the phase terminals W and W′ are connected to a common W-phase terminal 80W.

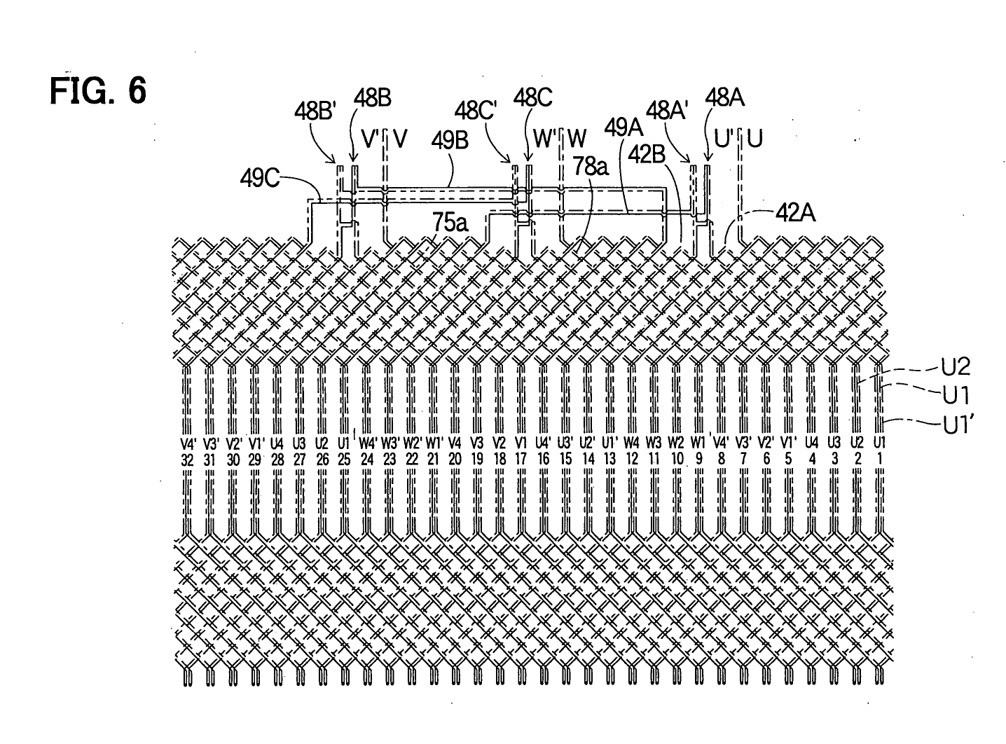

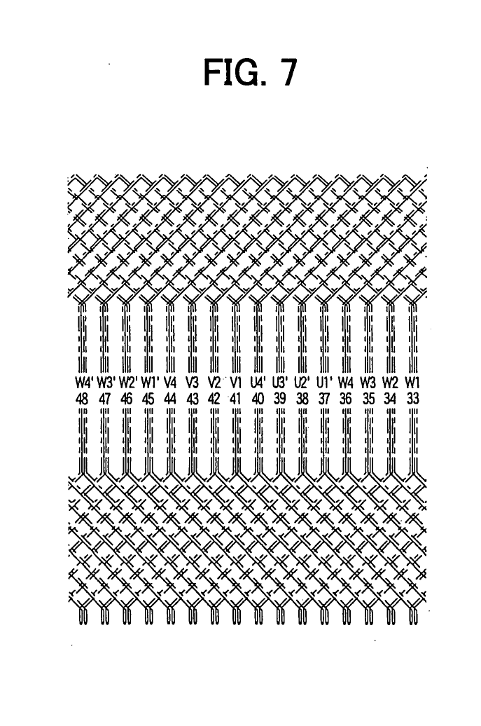

Referring to FIGS. 6 and 7, how the conductor segments 37, 42 are disposed in the slots 33 to form the armature winding 35 will be described in detail. The straight portion 38a of the inner conductor segment 37 and the straight portion 43a of the outer conductor segment 42 (refer to FIG. 3) are disposed in one slot 33, and the straight portion 38b of the inner conductor segment 37 and the straight portion 43b of the outer conductor segment 42 are disposed in the other slot 33. The former slot and the latter slot are 180° electrical angle apart from each other. In this manner, four strait portions of the conductor segments 37, 42 are disposed in each slot 33. The first layer in the slot 33 (the layer closest to the rotational axis of the motor) is shown in FIGS. 6 and 7 with a chained line with one dot, the second layer with a broken line, the third layer with a solid line and the fourth layer with a chained line with two dots.

As shown in FIGS. 6 and 7, the U-phase winding unit U1 is wound around the armature core (one round) in the following path: the second layer in the 1^{st} slot, the first layer in the 13^{th} slot, the fourth layer in the 25^{th} slot, the third layer in the 37^{th} slot, the fourth layer in the 1^{st} slot, and the third layer in the 13^{th} slot. The winding unit U2 is wound around the armature core (one round) from the second layer in the 2^{nd} slot, the first layer in the 14^{st} slot . . . , then connected to the junction 48A. The winding units U1 and U2 are connected to each other using a special segment 42A (straight portions in a regular segment are apart from each other by 12 slots, while those in a special segment by 11 slots). The winding unit U3 is wound around the armature core, starting from the junction 48A through the second layer in the 3^{rd} slot, the first layer in the 15^{th} th slot . . . and so on. The winding unit U4 starts from the second layer in the in the 4^{th} slot, which continues to the third layer in the 15^{th} slot, through the first layer in the 16^{th} . . . , and reaches the junction 48B. The winding units U3 and U4 are connected to each other using the special segment 42B. The W-phase winding unit W4 extending from the third layer in 24^{th} slot is connected to the junction 48A, at which U2 and U3 are connected, through a lead wire 49A.

The V-phase winding unit V1 extends from the 17^{th} slot . . . to the 5^{th} slot. V2 extends from the 18^{th} slot . . . to the 6^{th} slot. V3 extends from the 19^{th} slot . . . to the 7^{th} slot. V4 extends from the 20^{th} slot . . . to the 8^{th} slot. Each of the V-phase winding units V1-V4 makes one full round around the armature core. The U-phase winding unit U4 extending from the third layer in the 16^{th} th slot is connected to the junction 48B, at which V2 and V3 are connected, through a lead wire 49B.

The W-phase winding unit W1 extends from the 9^{th} slot . . . to the 45^{th} slot, W2 from the 10^{th} slot . . . to the 46^{th} slot, W3 from the 11^{th} slot . . . to the 47^{th} slot, and W4 from the 12^{th} slot . . . to the 48^{th} slot. Each of the W-phase winding units W1-W4 makes one round around the armature core. The V-phase winding unit V4 extending from the fourth layer in the 32^{nd} slot is connected to the junction 48C, at which W2 and W3 are connected, through a lead wire 49C.

The second U-phase winding Ub consisting of U1 and U2 is connected to the first U-phase winding Ua consisting of U3 and U4 at junction 48A which is in turn connected to the first W-phase winding Wa consisting of W3 and W4. Ub is connected to Ua after Ub makes two rounds around the armature core, and then Ua makes two rounds. The V-phase windings and the W-phase windings are connected in the same manner as the U-phase windings, as shown in FIGS. 4 and 5. The other delta-star winding 47′ is formed in the same manner. The pair of delta-star windings 47 and 47′, however, are wound in the opposite directions around the armature core 32. For example, U1 of the delta-star winding 47 extends from the second layer in the 1^{st} slot toward the left side in FIG. 6, while U1′ of the other delta-star winding 47′ extends from the first layer in the 1^{st} slot toward the right side.

As shown in FIG. 4, the pair of delta-star windings 47, 47′ are connected in parallel to each other. The U-phase winding unit U1 of the delta-star winding 47 and the U-phase winding unit U1′ of the other delta-star winding 47′ are commonly led out from the 1^{st} slot and connected to the common U-phase terminal 80U. Similarly, V1 and V1′ are commonly led out from the 17^{th} slot and connected to the common V-phase terminal 80V. W1 and W1′ are commonly led out from the 9^{th} slot and connected to the common W-phase terminal 80W.

Electric power to drive the motor is supplied from a direct current source (not shown) through an inverter (not shown) to the three-phase common terminals 80U, 80V and 80W. The electric motor is driven in the known manner, i.e., the positions of the permanent magnets 27 are detected, and current is supplied to a phase winding determined by the positions of the permanent magnets 27. The rotor 25 is rotated by electromagnetic force between the rotor 25 and the armature 30.

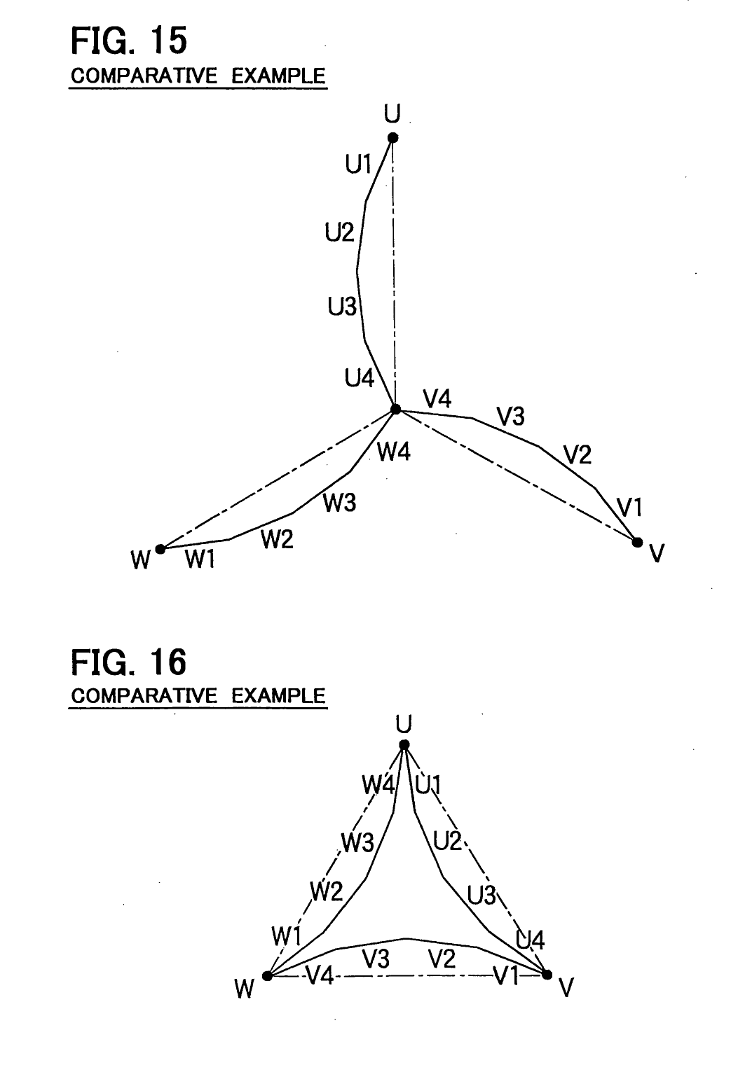

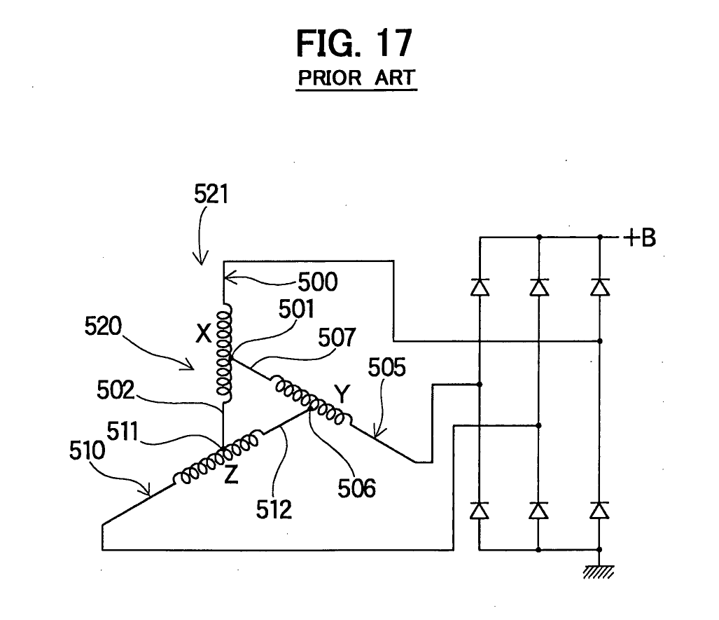

The following advantages are obtained in the first embodiment described above. First, the number of armature winding turns which lies between those of the delta-winding and the star-winding is realized. The number of winding turns (corresponding to the number of series conductors per each pole and each phase) of each phase winding unit (U1-U4, V1-V4, W1-W4) is 2. Therefore, the star-connection-equivalent number of turns in the delta winding 50 is: (2 +2)/\sqrt{3}≈2.3. Accordingly, the equivalent number of turns in the entire delta-start winding 47 is: 2+2+(2+2)/\sqrt{3}≈6.3. If the same winding units are connected in the star-connection as shown in FIG. 15 (comparative example), the equivalent number of turns is 8. On the other hand, if the same winding units are connected in the delta-connection as shown in FIG. 16 (comparative example), the equivalent number of turns is: 8/\sqrt{3}≈4.6. The equivalent number of turns 6.3 realized in the first embodiment lies between 8 in the star-connection and 4.6 in the delta-connection.

In the star-connection shown in FIG. 15, U4, V4 and W4 are connected at one common point. To change the star-connection shown in FIG. 15 to the delta-star connection shown in FIG. 5, one end of U4 is connected to a junction of V2 and V3. Other phase windings are similarly changed. On the other hand, to change the delta-connection shown in FIG. 16 to the delta-star connection shown in FIG. 5, one end of U4 is connected to a junction of V2 and V3. Other phase windings are similarly changed. Since the U-shaped portions 39, 44 of the conductor segments 37, 42 are positioned at the axial end of the armature core 32, these connection changes can be easily done.

Secondly, since the pair of delta-star windings 47 and 47′ are connected in parallel, a large current capacity can be realized. Thirdly, since the phase windings to be connected to the phase terminals are led out from the same slots which are common to both delta-star windings 47, 47′, the structure of the armature winding 35 can be made simple. Lastly, since the lead wires 49A, 49B and 49C are positioned within a half circular area (within 180° of the central angle) on the axial end of the armature core 32, the length of the lead wires can be shortened. By shortening the lead wires, the power loss can be reduced.

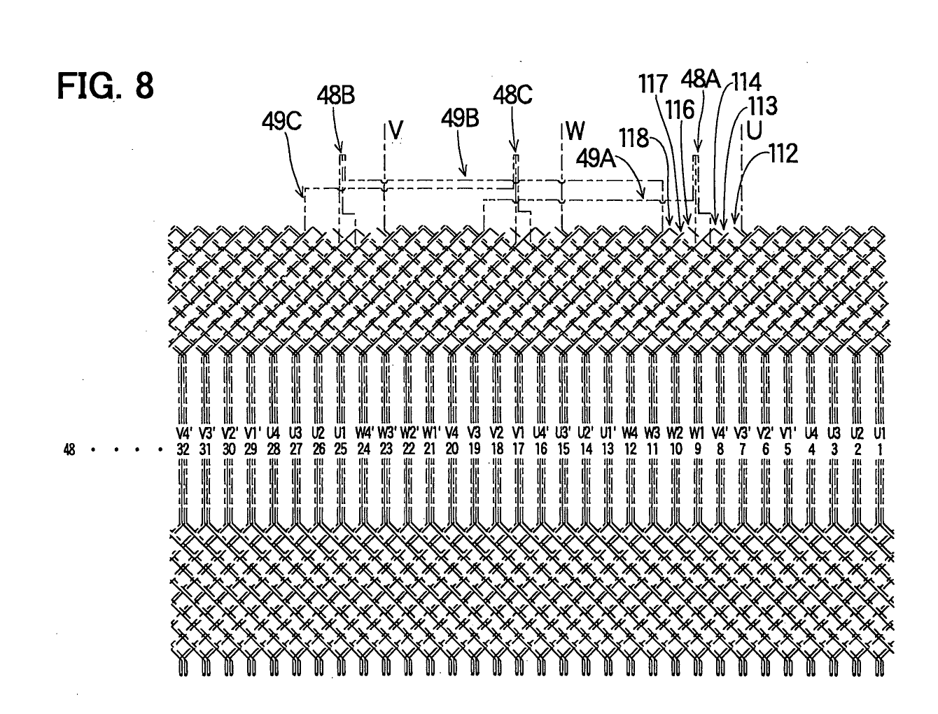

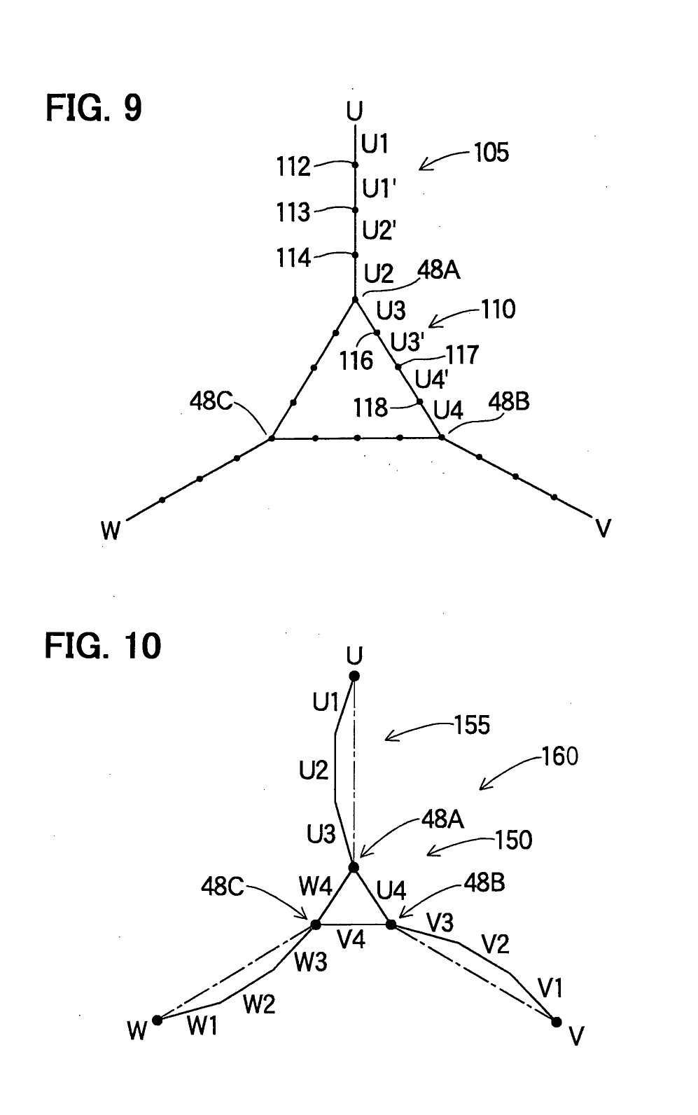

A second embodiment of the present invention will be described with reference to FIGS. 8 and 9. In this embodiment, phase-winding units of both the delta-star windings 47 and 47′ are connected in series. That is, as shown in FIG. 9, the winding units U1, U1′, U2′ and U2 are connected in series in this order, forming a U-phase winding in a star-winding 105. Other phase windings in the star-winding 105 are similarly formed. The winding units U3, U3′, U4′ and U4 are connected in series in this order, forming a U-phase winding in a delta-winding 110. Other phase windings in the delta-winding 110 are similarly formed.

In the star winding 105, as shown in FIG. 8, the U-phase winding unit U1 proceeds from the first layer in the 1^{st} slot toward the right side and reaches the fourth layer in the 13^{th} slot. U1′ proceeds from the second layer in the 1^{st} slot toward the left side and reaches the third layer in the 13^{th} slot. The fourth layer in the 13^{th} slot and the second layer in the 1^{st} slot are connected by a reversal conductor segment 112. U2′ proceeds from the second layer in the 2^{nd} slot toward the left side and reaches the third layer in the 14^{th} slot. The third layer in the 13^{th} slot and the second layer in the 2^{nd} nd slot are connected by a special segment 113. U2 proceeds from the first layer in the 2^{nd} nd slot toward the right side and reaches the fourth layer in the 14^{th} slot. The third layer in the 14^{th} slot and the first layer in the 2^{nd} slot are connected by a reversal segment 114. U2 extending from the fourth layer in the 14^{th} th slot is connected to the junction 48A.

In the delta-winding 110, U3 and U3′ are connected by a reversal segment 116, U3′ and U4′ are connected by a special segment 117, and U4′ and U4 are connected by a reversal segment 118. An end of U4 is connected to the junction 48B.

The equivalent number of turns (converted to a star-winding) of the delta-winding 110 is: (4+4)/\sqrt{3}≈4.5. The equivalent number of turns of the delta-star winding (a combination of 110 and 105) is: 8+8/\sqrt{3}≈12.6. In this second embodiment, the phase winding units, each proceeding in different directions, are connected in series by the reversal segments 112, 114, 116 and 118. In this manner, the pair of delta-star windings connected in parallel (as in the first embodiment) can be changed to the winding shown in FIG. 9 without making major changes. Since the equivalent number of turns in the second embodiment is high, the second embodiment is applicable to a higher voltage system.

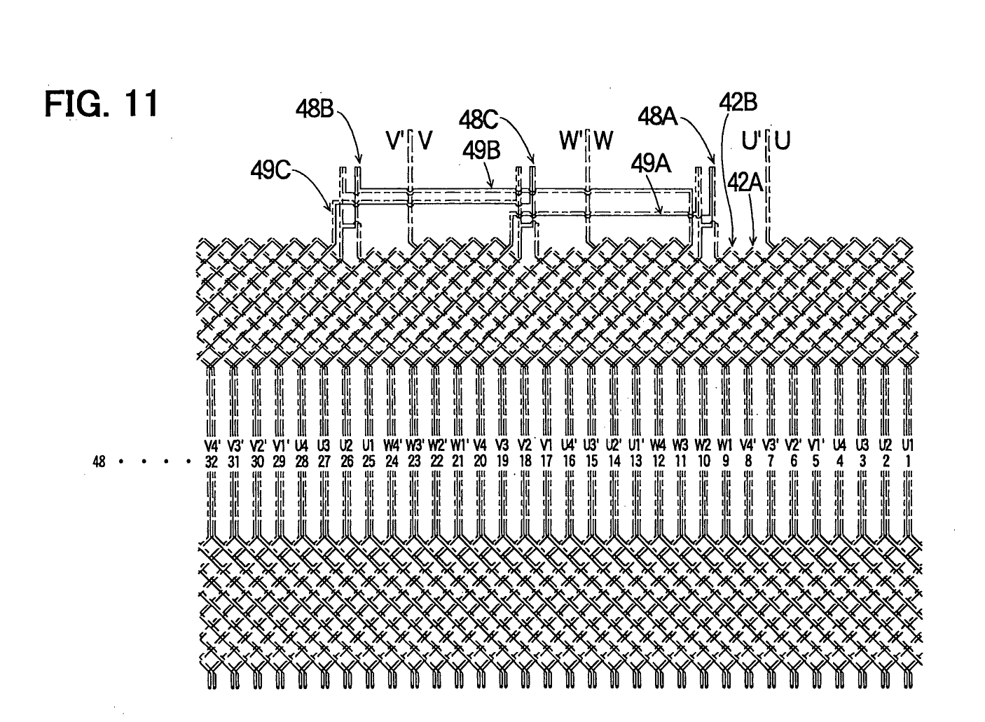

A third embodiment of the present invention will be described with reference to FIGS. 10 and 11. In this embodiment, a pair of the delta-star windings 160 shown in FIG. 10 are connected in parallel as in the first embodiment. However, the winding structure is modified from the first embodiment. That is, the delta-winding 150 is composed of U4, V4 and W4. In other words, each phase winding in the delta-winding 150 is formed only one phase winding unit. The rest of the phase windings (U1, U2 and U3 in the U-phase, for example) are all used for forming the star-winding 155.

The winding structure of the third embodiment is shown in FIG. 11. An end of U3 is led out from the 15^{th} slot, an end of U4 is led out from the 4^{th} slot, and an end of W4 is led out from the 24^{th} slot. These ends are connected at the junction 48A. An end of V3 is led out from the 31^{st} slot, an end of V4 is led out from 20^{th} slot, and an end of U4 is led out from the 16^{th} slot. These ends are connected at the junction 48B. An end of W3 led out from the 23^{rd} slot and an end of W4 led out from the 12^{th} slot and an end of V4 led out from the 32^{nd} slot are connected at the junction 48C.

The number of turns of each phase winding unit is all equal and 2. The equivalent number of turns of the delta-winding 150 is: 2/\sqrt{3}≈7. Accordingly, the equivalent number of turns of the delta-star winding 160 is: 6+2/\sqrt{3}≈7. If all the winding units are connected in a pure star-winding, the equivalent number of turns is 8. This means that the equivalent number of turns can be easily changed from 8 to 7 by simply changing the positions of the junctions 48A, 48B and 48C. Comparing this third embodiment with the first embodiment, led out positions of U2, U3 and U4 are slightly different. That is, U2 is led out from the 14^{th} slot in the first embodiment, while U3 is led out from the 15^{th} slot in the third embodiment. U3 is led out from the 3^{rd} slot in the first embodiment while U4 is led out from the 4^{th} slot in the third embodiment. Other phase windings V and W are similarly structured. Thus, the equivalent number of turns can be easily change by simply moving the positions of the junctions 48A, 48B and 48C. Comparing the third embodiment with the first embodiment, these positions are moved by only one slot. Though the pair of delta-star windings 160 are connected in parallel in this third embodiment, it is, of course, possible to connect them in series as done in the second embodiment.

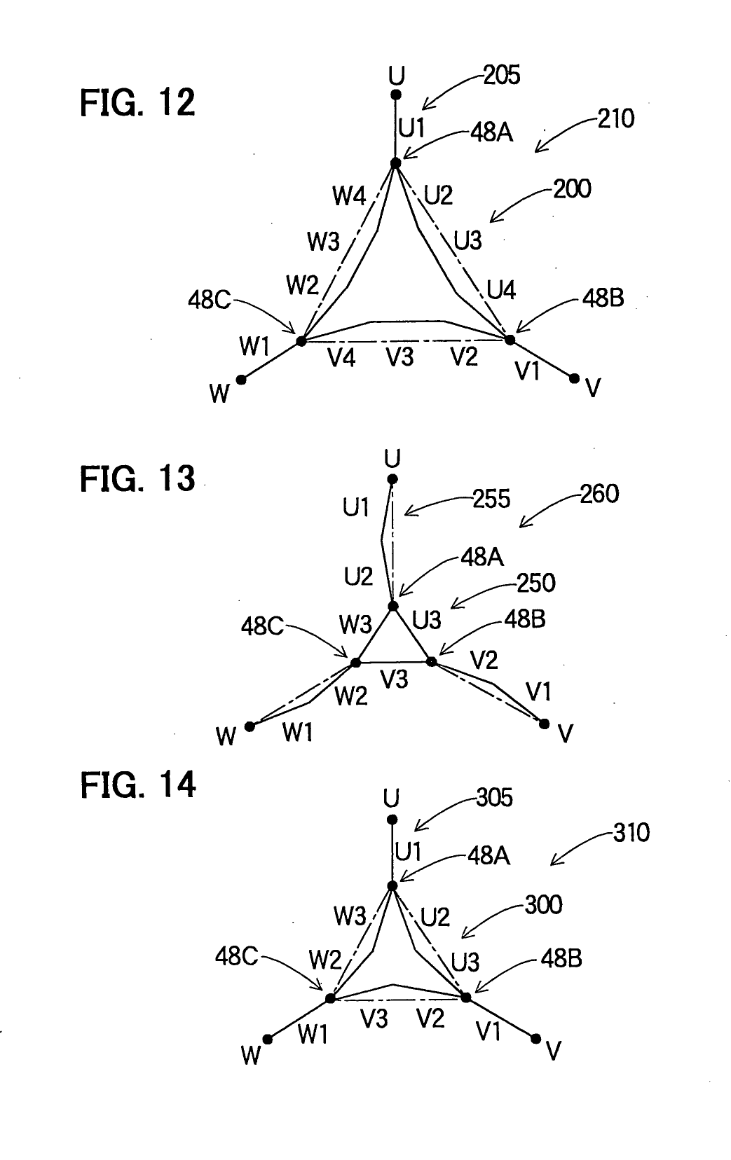

A fourth embodiment of the present invention will be described with reference to FIG. 12. A pair of delta-star windings 210 are connected in parallel in this embodiment, too. A delta-winding 200 is composed of three phase winding units in each phase, e.g., U2, U3 and U4 in the U-phase. In other words, each phase winding in the delta-winding 200 is formed by making three rounds around the armature core 32. A star-winding 205 is formed by only three phase winding units U1, V1 and W1. Since the number of turns of each phase winding unit is 2 (the same as in the foregoing embodiment), the equivalent number of turns (the star-winding equivalent) of the delta-winding 200 is: 6/\sqrt{3}≈3.4. Accordingly, the equivalent number of turns of the delta-star winding 210 is: 2+6/\sqrt{3}≈5.4. The equivalent number of turns 8 in the pure star-connection is changed to 5.4 by simply changing the positions of the junctions 48A, 48B and 48C.

Though the pair of the delta-star winding 210 are connected in parallel in this embodiment, it is also possible to connect each winding unit in series as in the second embodiment. By connecting two phase winding units in series, the number of turns becomes 4 each. Accordingly, the equivalent number of turns of the delta-star winding becomes: 4+12/\sqrt{3}≈11. As understood from the first embodiment, the third embodiment and the fourth embodiment, it is possible to change the positions of the junctions at three steps, because each phase includes four winding units, e.g., U1, U2, U3 and U4 in the U-phase. By simply changing the positions of the junctions, the motor can be made applicable to the systems having various voltages and various current capacities. Further, in the first, third and fourth embodiments, it is possible to switch the pair of delta-star windings connected in parallel to the series connection by simply changing the positions of the junctions using the reversal segments.

A fifth embodiment of the present invention will be described with reference to FIG. 13. A pair of delta-star windings 260 are connected in series in this embodiment, too. In this embodiment, however, three winding units are used in each phase instead of four winding units. That is, U-phase winding is formed three winding units U1, U2 and U3 connected in series. The same is applied to other phases V and W. A delta winding 250 is formed by U3, V3 and W3 connected in delta connection at junctions 48A, 48B and 48C. A star-winding 255 is formed by six winding units U1, U2; V1, V2; W1, W2. Each winding unit forming the delta-winding 250, i.e., U3, V3, W3, is connected to the junction 48A, 48B, 48C after making one round around the armature core 32.

The equivalent number of turns of the delta-winding 250 is: 2/\sqrt{3}≈1. Accordingly, the equivalent number of turns of the delta-star winding 260 is: 4+2/\sqrt{3}≈5. If all the winding units are connected in pure star-connection, the equivalent number of turns is 6. This means that the equivalent number of turns 5 is realized by simply changing the positions of the junctions. The pair of delta-star windings 260 may be connected in series in the similar manner as in the second embodiment. In this case, the equivalent number of turns is: 8+4/\sqrt{3}≈10.3.

A sixth embodiment of the present invention will be described with reference to FIG. 14. A delta-star winding 310 is composed of a delta-winding 300 and a star-winding 305. In this embodiment, the junctions 48A, 48B, 48C in the fifth embodiment are moved to enlarge the delta-winding 300. Each phase winding (composed of two winding units) in the delta-winding 300 is connected in a delta-connection after it makes two rounds around the armature core 32. Since one round includes two winding turns, each phase of the delta-winding 300 includes four turns. The star-winding 305 is formed by three winding units U1, V1 and W1. The equivalent number of turns of the delta-star winding 310 is: 2+4/\sqrt{3}≈4.3. A pair of delta-star windings 310 may be connected in series in the same manner as in the second embodiment. In this case, the equivalent number of turns is: 4+8/\sqrt{3}≈8.6

While the present invention has been shown and described with reference to the foregoing preferred embodiments, it will be apparent to those skilled in the art that changes in form and detail may be made therein without departing from the scope of the invention as defined in the appended claims.

1. An armature of a rotary electric machine, the armature including a cylindrical armature core having a plurality of slots and an armature winding wound around the armature core, the armature winding comprising a plurality of conductor segments, each having a pair of straight portions disposed in the slots and a U-shaped portion connecting the pair of straight portions, wherein:
the armature winding is a delta-star winding which is a combination of a delta-winding connected in a delta-connection and a star-winding connected in a star-connection;
the delta-winding is composed of first three phase windings, a first U-phase winding (Ua), a first V-phase winding (Va), and a first W-phase winding (Wa), each first phase winding being wound by n (integer) turns;
the star-winding is composed of second three phase windings, a second U-phase winding (Ub) one end of which is connected to a point (48A) connecting (Ua) and (Wa), a second V-phase winding (Vb) one end of which is connected to a point (48B) connecting (Ua) and (Va), and a second W-phase winding (Wb) one end of which is connected to a point (48C) connecting (Va) and (Wa), each second phase winding being wound by m (integer) turns; and
the armature winding includes turn-ratio changing means for changing a turn-ratio (n/m) by changing positions of the points (48A), (48B) and (48C).

2. The armature of a rotary electric machine as in claim 1, wherein:
a U-phase winding is composed of three or more U-phase winding units (U1, U2, U3 . . . ) connected in series, a part of such units constitutes the first U-phase winding (Ua) and the rest constitutes the second U-phase winding (Ub);
a V-phase winding is composed of three or more V-phase winding units (V1, V2, V3 . . . ) connected in series, a part of such units constitutes the first V-phase winding (Va) and the rest constitutes the second V-phase winding (Vb); and
a W-phase winding is composed of three or more W-phase winding units (W1, W2, W3 . . . ) connected in series, a part of such units constitutes the first W-phase winding (Wa) and the rest constitutes the second W-phase winding (Wb).

3. The armature of a rotary electric machine as in claim 2, wherein:
lead wires led out from all of the first and second three-phase windings (Ua, Ub, Va, Vb, Wa, Wb) are positioned at one axial end of the cylindrical armature core within 180 degrees in the central angle of the armature core.

4. An armature of a rotary electric machine, the armature including a cylindrical armature core having a plurality of slots and an armature winding wound around the armature core, the armature winding comprising a plurality of conductor segments, each having a pair of straight portions disposed in the slots and a U-shaped portion connecting the pair of straight portions, wherein:
the armature winding is composed of a pair of delta-star windings which are connected in parallel, each delta-star winding being a combination of a delta-winding connected in a delta-connection and a star-winding connected in a star-connection;
the delta-winding is composed of first three phase windings, a first U-phase winding (Ua), a first V-phase winding (Va), and a first W-phase winding (Wa), each first phase winding being wound by n (integer) turns;
the star-winding is composed of second three phase windings, a second U-phase winding (Ub) one end of which is connected to a point (48A) connecting (Ua) and (Wa), a second V-phase winding (Vb) one end of which is connected to a point (48B) connecting (Ua) and (Va), and a second W-phase winding (Wb) one end of which is connected to a point (48C) connecting (Va) and (Wa), each second phase winding being wound by m (integer) turns; and
the armature winding includes turn-ratio changing means for changing a turn-ratio (n/m) by changing positions of the points (48A), (48B) and (48C).

5. The armature of a rotary electric machine as in claim 4, wherein:
the first U-phase windings (Ua) of both the delta-star windings, the first V-phase windings (Va) of both the delta-star windings, the first W-phase windings (Wa) of both the delta-star windings, the second U-phase windings (Ub) of both the delta-star windings, the second V-phase windings (Vb) of both the delta-star windings and the second W-phase windings (Wb) of both the delta-star windings are disposed in a same slot, respectively, and have lead wires extending from the same slot, respectively.

6. The armature of a rotary electric machine as in claim 5, wherein:
the lead wires extending from all of the first and second phase windings (Ua, Va, Wa, Ub, Vb, Wb) of the both delta-star windings are positioned at one axial end of the cylindrical armature core within 180 degrees in the central angle of the armature core.

7. An armature of a rotary electric machine, the armature including a cylindrical armature core having a plurality of slots and an armature winding wound around the armature core, the armature winding comprising a plurality of conductor segments, each having a pair of straight portions disposed in the slots and a U-shaped portion connecting the pair of straight portions, wherein:
the armature winding is composed of a pair of delta-star windings, each delta-star winding being a combination of a delta-winding connected in a delta-connection and a star-winding connected in a star-connection;
the delta-winding is composed of first three phase windings, a first U-phase winding (Ua), a first V-phase winding (Va), and a first W-phase winding (Wa);
the star-winding is composed of second three phase windings, a second U-phase winding (Ub) one end of which is connected to a point (48A) connecting (Ua) and (Wa), a second V-phase winding (Vb) one end of which is connected to a point (48B) connecting (Ua) and (Va), and a second W-phase winding (Wb) one end of which is connected to a point (48C) connecting (Va) and (Wa); and
the armature winding includes connection changeover means for changing a connection in the pair of delta-star windings between a series connection, in which each phase winding in one delta-star winding is connected in series to each phase winding in the other delta-star winding, and a parallel connection in which both the delta-star windings are connected in parallel as a whole.
